(19) United States
(12) Patent Application Publication
(10) Pub. No.: US 2012/0200661 A1
(43) Pub. Date: Aug. 9, 2012

(54) Reserved Space in a Videoconference Layout

(76) Inventor: Wayne E. Mock, Round Rock, TX (US)

(21) Appl. No.: 13/020,364

(22) Filed: Feb. 3, 2011

(51) Int. Cl. H04N 7/15

(52) U.S. Cl. 348/14.09; 348/E07.084

(57) ABSTRACT

Reserving a space in a videoconference layout. The videoconference layout may be displayed at a first participant endpoint and may include images of a plurality of participants during the videoconference. A first portion of the videoconference layout may include a plurality of portions for the plurality of participants. A second portion of the videoconference layout may be used for an active speaker of the plurality of participants. When a first participant displayed in a first portion of the plurality of portions becomes an active speaker in the videoconference, the first participant may be displayed in the second portion of the videoconference layout and the first portion of the plurality of portions may be reserved for the first participant.

### FIELD OF THE INVENTION

The present invention relates generally to videoconferencing and, more specifically, to reserving a space in a videoconference layout.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to one or more other (remote) participants. Each videoconferencing system may also include a display and speaker to reproduce video and audio received from remote participant(s).

During a videoconference each participant may view a corresponding videoconference layout which may include one or more video images of the other participants. However, the videoconference layout often changes throughout the videoconference as the active speaker changes. Accordingly, improvements in videoconferences are desired.

### SUMMARY OF THE INVENTION

Various embodiments are presented of a system and method for reserving a space in a videoconference layout, such as for an active talker in the videoconference. More specifically, in one embodiment the videoconference layout includes portions for each of a plurality of participants as well as an active talker region. When one of the displayed participants becomes an active talker, the portion of the layout that had previously been displaying the current active talker is “reserved” for that participant (e.g., is not used for other participants). This operates to maintain a more consistent view of the participants in the layout.

Initially, a videoconference may be established among a plurality of videoconferencing endpoints. Each videoconferencing endpoint may provide videoconferencing capabilities for one or more participants of the videoconference.

During the videoconference, each videoconferencing endpoint may provide a videoconference layout on a display of the videoconferencing endpoint. For example, a first videoconferencing endpoint may display a first videoconference layout at a first time. The first videoconference layout may include a first portion and a second portion. The first portion may be used to display images of a participant who is the current “active speaker” (e.g., the participant who is doing the majority of the current talking in the videoconference). Accordingly, the first portion may be referred to as the “active speaker” portion of the videoconference layout. The second portion may be used to display images of other participants in the videoconference (e.g., all or a subset of the remaining participants). The second portion may be referred to as the “continuous presence” portion of the videoconference layout. The second portion may include a plurality of subportions, e.g., one for each other participant of the videoconference.

The active speaker portion may generally be larger than each of the subportions and, in some embodiments, may be larger than the entire continuous presence portion of the videoconference layout. The active speaker portion may also be generally in the center or middle of the videoconference layout. The continuous presence portion of the videoconference layout may be provided along a side of the videoconference layout. For example, the continuous presence portion may form a border of the layout along the bottom, top, left, and/or right sides of the videoconference layout. In one embodiment, the continuous presence portion may only be along one side, may be along two sides (e.g., in an “L” shape), may be along three sides, and/or may be along four sides, as desired.

Additionally, the participant(s) at the first videoconferencing endpoint may select the number of subportions in the continuous presence portion (e.g., whether all other participants are included, or a number of participants to be included). In some embodiments, the participant(s) at the first videoconferencing endpoint may select the number by selecting a desired layout, providing a specified number, selecting the desired participants, etc.

Thus, at a first time, a first participant may be displayed as an active speaker in the active speaker portion of the videoconference layout. At the first time, a first subportion of the continuous presence portion of the videoconference layout may be reserved for the first participant when the first participant is not the active speaker. Additionally, at the first time, a second participant may be displayed in a second subportion of the continuous presence portion of the videoconference layout.

At a second time, after the second participant becomes the active speaker (and thus, the first participant is no longer the active speaker), the second participant may be displayed as the active speaker at in the active speaker portion of the videoconference layout. At this time, the second subportion (occupied by the second participant during the first time) may be reserved for the second participant until the second participant is no longer the active speaker. Additionally, the first participant may be displayed in the first subportion of the continuous presence portion of the videoconference layout.

Thus, a participant may be typically displayed in a particular subportion of the continuous portion of the videoconference until he becomes the active talker. At this point, the participant is promoted to the active speaker portion and the previous subportion is reserved for that participant for when the participant is no longer the active speaker. Accordingly, the locations of participants within the videoconference layout remains stable throughout a videoconference rather than prior systems in which the active speaker and the new active speaker swap positions, resulting in constantly moving participant locations in the layout.

The reserved space may be reserved in any of various different manners. For example, in one embodiment, the reserved space may be blank (e.g., may be a solid color such as black or white). The reserved space may include a static image (e.g., of the participant or indicating the participant), an icon (e.g., indicating that the space is reserved), text indicating the reserved nature of the subportion (e.g., with the text “reserved”), etc. In further embodiments, the participant may be displayed in both the active speaker portion and the reserved portion of the videoconference layout. For example, in one embodiment, the level of transparency of the participant in the reserved portion may be different than the other portions, e.g., it may have a 50% (or other percent) transparency layer applied, which may visually indicate to the user that the portion is “reserved”. One aspect of the term “reserved” in this context is that the reserved space is not used to display other participants in the videoconference.

In other words, if a first portion of the layout displays a first participant, and the first participant becomes the active talker and is displayed in the active talker region, the first portion is reserved such that no other participants (no participants other than the first participant) are displayed in this first portion. Thus when the first participant is no longer the active talker, the first participant can return to being displayed in this first portion of the layout. This avoids unnecessary “re-shuffling” of the participants in the layout, and thus provides a more pleasing display for the participant viewer.

The method may continue for other participants, e.g., where a third participant is displayed as the active talker and a third subportion is reserved for the third participant. Additionally, the participant(s) at the first videoconferencing endpoint may be able to select another videoconference layout (e.g., which may or may not include an active talker portion), e.g., from a plurality of available videoconference layouts.

### BRIEF DESCRIPTION OF THE DRAWINGS

A better understanding of the present invention may be obtained when the following detailed description is considered in conjunction with the following drawings, in which:

FIGS. 1 and 2 illustrate exemplary videoconferencing system participant locations, according to an embodiment;

FIGS. 3A and 3B illustrate exemplary conferencing systems coupled in different configurations, according to some embodiments;

FIG. 4 is a flowchart diagram illustrating an embodiment of a method for recording a videoconference; and

FIGS. 5A-5F, 6A-6C, and 7A-7F illustrate exemplary screen layouts for a videoconference, according to one embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.
U.S. patent application titled “Virtual Decoders”, Ser. No. 12/142,263, which was filed Jun. 19, 2008, whose inventors are Keith C. King and Wayne E. Mock, is hereby incorporated by reference in its entirety as though fully and completely set forth herein.
U.S. patent application titled “Video Conferencing System which Allows Endpoints to Perform Continuous Presence Layout Selection”, Ser. No. 12/142,302, whose inventors are Keith C. King and Wayne E. Mock, is hereby incorporated by reference in its entirety as though fully and completely set forth herein.
U.S. patent application titled “Video Conferencing Device which Performs Multi-way Conferencing”, Ser. No. 12/142,340, whose inventors are Keith C. King and Wayne E. Mock, is hereby incorporated by reference in its entirety as though fully and completely set forth herein.
U.S. patent application titled “Video Decoder which Processes Multiple Video Streams”, Ser. No. 12/142,377, whose inventors are Keith C. King and Wayne E. Mock, is hereby incorporated by reference in its entirety as though fully and completely set forth herein.
U.S. patent application titled “Virtual Multiway Scaler Compensation”, Ser. No. 12/171,358, whose inventors are Keith C. King and Wayne E. Mock, is hereby incorporated by reference in its entirety as though fully and completely set forth herein.
U.S. patent application titled “Virtual Distributed Multipoint Control Unit”, Ser. No. 12/712,947, whose inventors are Keith C. King, Ashish Goyal, and Hrishikesh Gopal Kulkarni, is hereby incorporated by reference in its entirety as though fully and completely set forth herein.

### Terms

The following is a glossary of terms used in the present application:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as a physical transmission medium, such as a bus, network, and/or other physical transmission medium that conveys signals such as electrical, electromagnetic, or digital signals.

Computer System—any of various types of computing or processing systems, including a personal computer system (PC), mainframe computer system, workstation, network appliance, Internet appliance, personal digital assistant (PDA), smart phone, television system, grid computing system, or other device or combinations of devices. In general, the term “computer system” can be broadly defined to encompass any device (or combination of devices) having at least one processor that executes instructions from a memory medium.

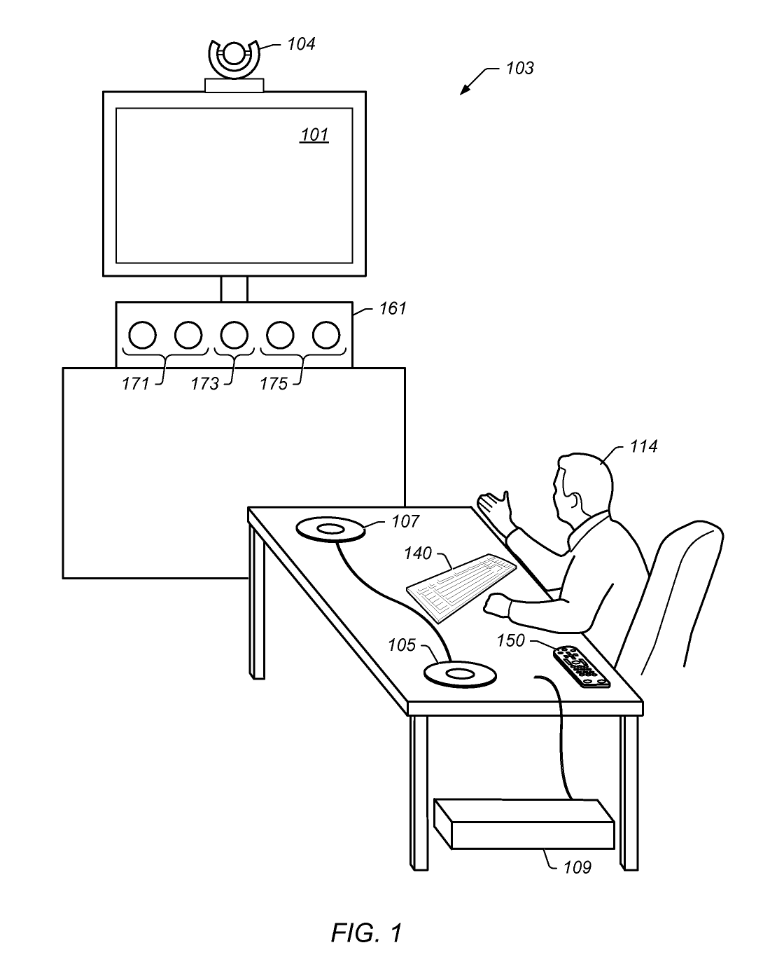

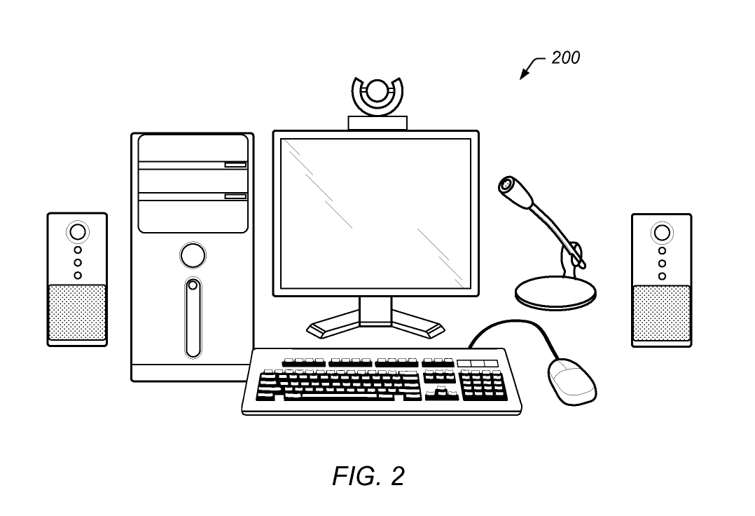

### FIGS. 1 and 2—Exemplary Participant Locations

FIG. 1 illustrates an exemplary embodiment of a videoconferencing participant location, also referred to as a videoconferencing endpoint or videoconferencing system (or videoconferencing unit). The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference. In some embodiments, images acquired by the camera 104 may be encoded and transmitted to a multipoint control unit (MCU), which then provides the encoded stream to other participant locations (or videoconferencing endpoints)

The participant location may further include one or more input devices, such as the computer keyboard 140. In some embodiments, the one or more input devices may be used for the videoconferencing system 103 and/or may be used for one or more other computer systems at the participant location, as desired.

The participant location may also include a sound system 161. The sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together.

In some embodiments, the videoconferencing system components (e.g., the camera 104, display 101, sound system 161, and speakerphones 105/107) may be coupled to a system codec 109. The system codec 109 may be placed on a desk or on the floor. Other placements are also contemplated. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system, or to an MCU for provision to other conferencing systems. The conferencing system may be controlled by a participant or user through the user input components (e.g., buttons) on the speakerphones 105/107 and/or input devices such as the keyboard 140 and/or the remote control 150. Other system interfaces may also be used.

In various embodiments, the codec 109 may implement a real time transmission protocol. In some embodiments, the codec 109 (which may be short for “compressor/decompressor” or “coder/decoder”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may utilize MPEG, Indeo™, and Cinepak™, among others.

In some embodiments, the videoconferencing system 103 may be designed to operate with normal display or high definition (HD) display capabilities. The videoconferencing system 103 may operate with network infrastructures that support T1 capabilities or less, e.g., 1.5 mega-bits per second or less in one embodiment, and 2 mega-bits per second in other embodiments.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system 200 with a video camera, input devices, microphone and/or speakers such as the videoconferencing system of FIG. 2). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

Note that the videoconferencing system shown in FIGS. 1 and 2 may be modified to be an audioconferencing system. For example, the audioconference could be performed over a network, e.g., the Internet, using VOIP. The audioconferencing system, for example, may simply include speakerphones 105/107, although additional components may also be present. Additionally, note that any reference to a “conferencing system” or “conferencing systems” may refer to videoconferencing systems or audio conferencing systems (e.g., teleconferencing systems). In the embodiments described below, the conference is described as a videoconference, but note that the methods may be modified for utilization in an audioconference.

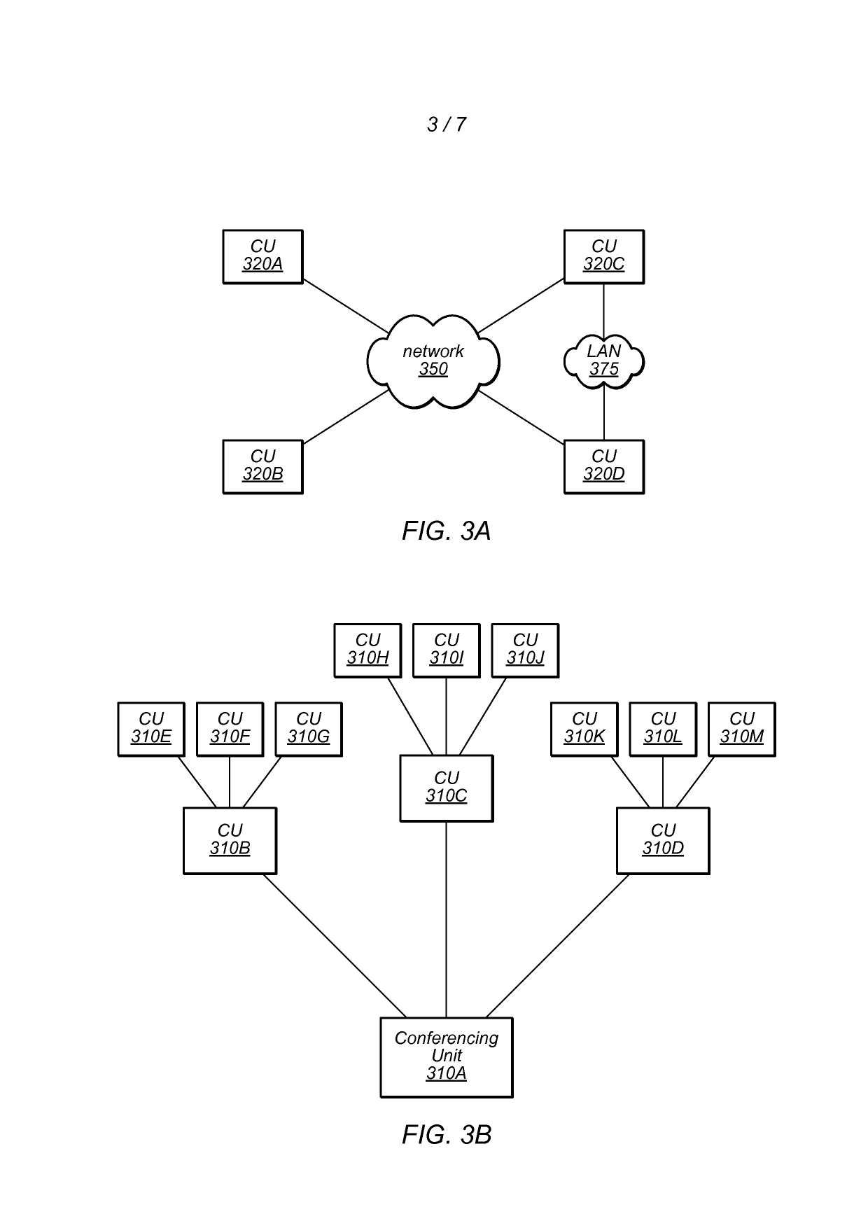

### FIGS. 3A and 3B—Coupled Conferencing Systems

FIGS. 3A and 3B illustrate different configurations of conferencing systems. The conferencing systems may be operable to perform the methods described herein. As shown in FIG. 3A, conferencing systems (CUs) 320A-D (e.g., videoconferencing systems 103 described above) may be connected via network 350 (e.g., a wide area network such as the Internet) and CU 320C and 320D may be coupled over a local area network (LAN) 375. The networks may be any type of network (e.g., wired or wireless) as desired.

FIG. 3B illustrates a relationship view of conferencing systems 310A-310M. As shown, conferencing system 310A may be aware of CU 310B-310D, each of which may be aware of further CU's (310E-310G, 310H-310J, and 310K-310M respectively). CU 310A may be operable to perform the methods described herein. In a similar manner, each of the other CUs shown in FIG. 3B, such as CU 310H, may be able to perform the methods described herein, as described in more detail below. Similar remarks apply to CUs 320A-D in FIG. 3A.

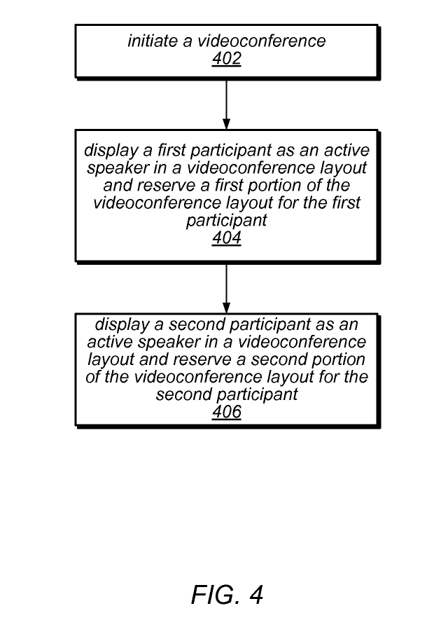

### FIG. 4—Reserving a Space in a Videoconference

FIG. 4 illustrates a method for reserving a space in a videoconference. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a videoconference may be initiated or performed between a plurality of participants at respective participant locations. More specifically, the conference may be initiated between a first participant using a first endpoint (e.g., at a first participant location) and a plurality of other participants using other endpoints (e.g., at other participant locations). Thus, endpoints may be similar to those described above regarding FIGS. 1-3B, although other variations are envisioned. The videoconference may be established according to any of a variety of methods, e.g., the one described in patent application Ser. No. 11/252,238, which was incorporated by reference above. The videoconference may utilize an instant messaging service or videoconferencing service over the Internet, as desired. In some embodiments, a multipoint control unit (MCU) may perform the first videoconference between the plurality of videoconference endpoints. For example, one of the endpoints (e.g., the first endpoint) may act as the MCU and may perform decoding and encoding operations on video information transmitted in the first videoconference between the plurality of videoconferencing endpoints.

During the videoconference, each videoconferencing endpoint may provide a videoconference layout on a display of the videoconferencing endpoint. The videoconference layout may be selected by the participant or may be selected automatically (e.g., based on the number of participants or endpoints in the videoconference). For example, the participant(s) at a location may select a desired layout from a plurality of available layouts and/or the endpoint may automatically select a layout that is appropriate the number of participants.

In some embodiments, the videoconference layout may include a first portion and a second portion. The first portion may be used to display images of a participant who is the current “active speaker” (e.g., the participant who is doing the majority of the current talking in the videoconference). Accordingly, the first portion may be referred to as the “active speaker” or “prominent” portion of the videoconference layout. However, it should be noted that the first portion may be used for other purposes than for the active speaker, as desired (in these cases, the method may still operate as described). The second portion may be used to display images of other participants in the videoconference (e.g., all or a subset of the remaining participants). The second portion may be referred to as the “continuous presence” portion of the videoconference layout.

The “continuous presence” portion may allow the participant to view participants who are not the active speaker. This second portion may include a plurality of subportions, e.g., one for each other participant of the videoconference. Note that in the descriptions herein, the images of the participants being displayed in the layout may be referred to simply as ‘the participants being displayed in the layout’, i.e., the participants which the images are intended to represent; it should accordingly be understood that this usage does not refer to literal participants.

The active speaker portion may generally be larger than each of the subportions and, in some embodiments, may be larger than the entire continuous presence portion of the videoconference layout. The active speaker portion may also be generally in the center or middle of the videoconference layout. The continuous presence portion of the videoconference layout may be provided along a side of the videoconference layout. For example, the continuous presence portion may form a border of the layout along the bottom, top, left, and/or right sides of the videoconference layout. In one embodiment, the continuous presence portion may only be along one side, may be along two sides (e.g., in an “L” shape), may be along three sides, and/or may be along four sides, as desired.

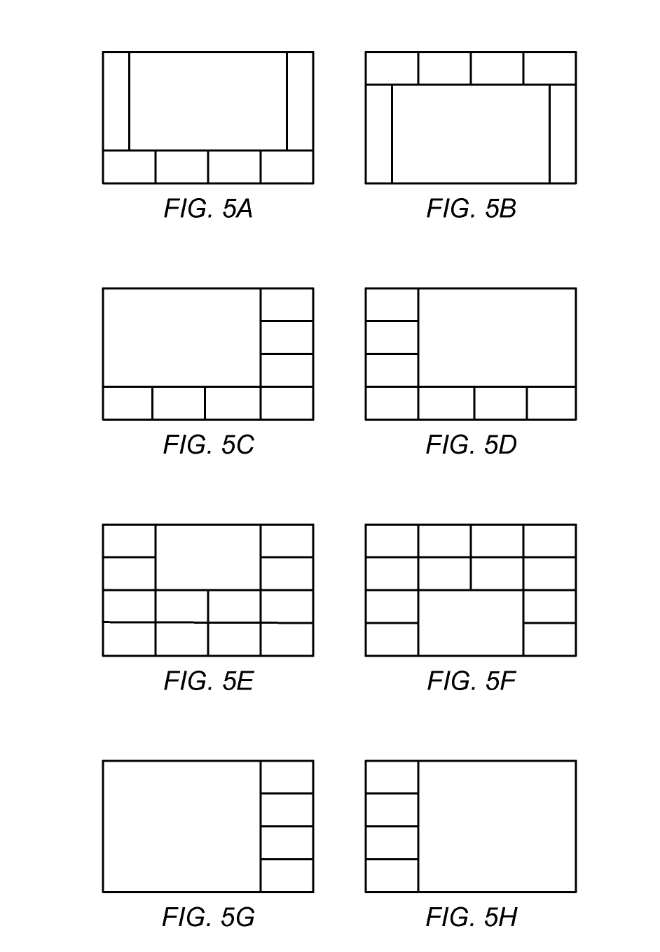

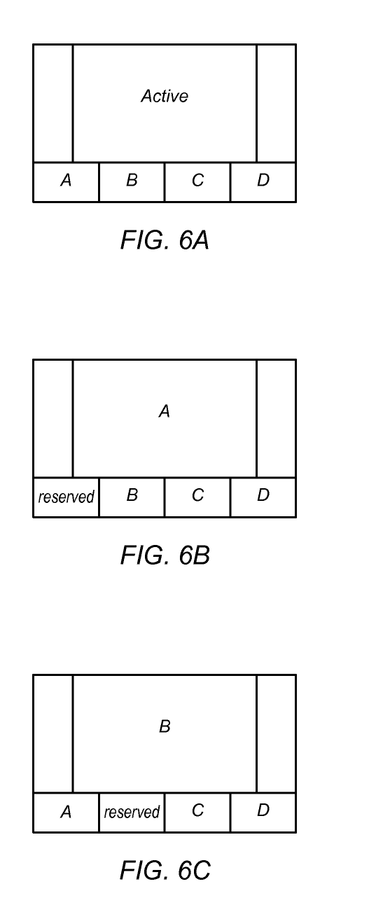

FIGS. 5A-5H illustrate various different videoconference layouts that may include a “active speaker” portion and a “continuous presence” portion as described above. More specifically, FIG. 5A illustrates a videoconference layout where the active speaker portion takes up the top middle portion of the layout and the continuous presence portion is along the bottom (in this case, split into four subportions). FIG. 5B illustrates a similar layout where the active speaker portion is along the bottom and the continuous presence portion is along the top. FIGS. 5A and 5B may accommodate four participants according to the method described herein. FIG. 6A illustrates the exemplary layout of FIG. 5A with labels. As shown, the active speaker may be displayed in the active speaker portion, and participants A, B, C, and D may have respective subportions of the continuous presence portion.

FIG. 5C illustrates a layout where the active speaker portion occupies the top left of the layout and the continuous presence portion forms a border along the bottom and right. FIG. 5D illustrates a similar layout where the continuous presence portion forms a border along the bottom and left sides. Further similar layouts are envisioned as well (e.g., top and left, top and right, top and bottom, left and right, etc.). FIGS. 5C and 5D may accommodate seven participants according to the method described herein.

Finally, FIG. 5E illustrates a layout where the active speaker portion may be in the top middle and the continuous presence portion may cover the left, right, and bottom sides. Similarly, FIG. 5F illustrates a layout where the active speaker portion may be in the bottom middle and the continuous presence portion may cover the left, right, and top sides. As can be seen, there are many variations possible for the geometric pattern shown in FIGS. 5E and 5F and they are all envisioned. The layouts of FIGS. 5E and 5F may accommodate twelve participants according to the method described herein.

In one embodiment, the participant(s) at the first videoconferencing endpoint may select the number of subportions in the continuous presence portion (e.g., whether all other participants are included, or a number of participants to be included). In some embodiments, the participant(s) at the first videoconferencing endpoint may select the number by selecting a desired layout, providing a specified number, selecting the desired participants, etc.

Thus, in 404, at a first time, a first participant may be displayed as an active speaker in the active speaker portion of the videoconference layout. At the first time, a first subportion of the continuous presence portion of the videoconference layout may be reserved for the first participant when the first participant is not the active speaker. Additionally, at the first time, a second participant may be displayed in a second subportion of the continuous presence portion of the videoconference layout.

FIG. 6B illustrates 404 for the exemplary layout of FIG. 5A. As shown, participant A (the first participant) is shown in the active speaker portion and the bottom left subportion is reserved for participant A (where participant A was shown in FIG. 6A).

In 406, at a second time, after the second participant becomes the active speaker (and thus, the first participant is no longer the active speaker), the second participant may be displayed as the active speaker at in the active speaker portion of the videoconference layout. At this time, the second subportion (occupied by the second participant during the first time) may be reserved for the second participant until the second participant is no longer the active speaker. Additionally, the first participant may be displayed in the first subportion of the continuous presence portion of the videoconference layout.

FIG. 6C illustrates 406 for the exemplary layout of FIG. 5A. As shown, participant B (the second participant) is shown in the active speaker portion and the second subportion from the bottom left (where participant B was displayed in FIGS. 6A and 6B) is reserved for participant B. As also shown in FIG. 6C, participant A has returned to his subportion space at the bottom left (as also shown in FIG. 6A).

Thus, a participant may be typically displayed in a particular subportion of the continuous portion of the videoconference until he becomes the active talker. At this point, the participant is promoted to the active speaker portion and the previous subportion is reserved for that participant for when the participant is no longer the active speaker. Accordingly, the locations of participants within the videoconference layout remains stable throughout a videoconference rather than prior systems in which the active speaker and the new active speaker swap positions, resulting in constantly moving participant locations.

The reserved space may be reserved in any of various different manners. For example, in one embodiment, the reserved space may be blank (e.g., may be a solid color such as black or white). The reserved space may include a static image (e.g., of the participant or indicating the participant), an icon (e.g., indicating that the space is reserved), text indicating the reserved nature of the subportion (e.g., with the text “reserved”), etc. In further embodiments, the participant may be displayed in both the active speaker portion and the reserved portion of the videoconference layout.

The method may continue for other participants, e.g., where a third participant is displayed as the active talker and a third subportion is reserved for the third participant. Additionally, the participant(s) at the first videoconferencing endpoint may be able to select another videoconference layout (e.g., which may or may not include an active talker portion), e.g., from a plurality of available videoconference layouts.

### FURTHER EMBODIMENTS

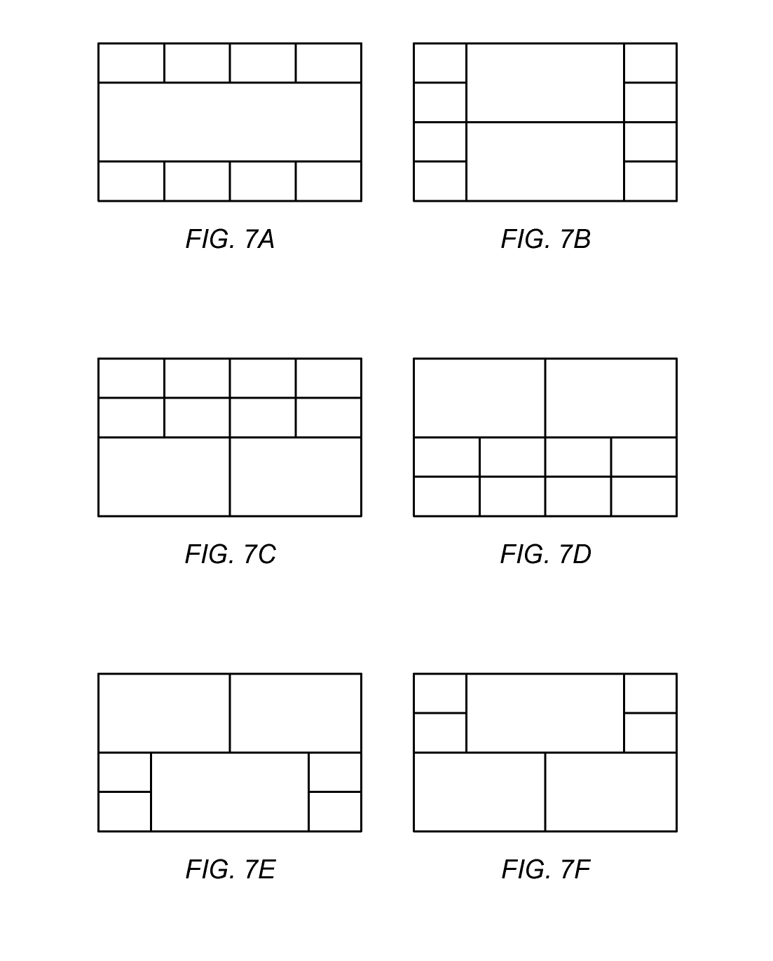

The method described above may further apply to videoconference layouts that include more than one “active speaker” or “prominent” portions in the videoconference layout. Said another way, the “active speaker” portion may include a plurality of subportions, as desired. For example, FIGS. 7A-7D illustrate exemplary layouts with two prominent portions and FIGS. 7E and 7F illustrate exemplary layouts with three prominent portions, although further layouts and variations thereon are envisioned.

For layouts with more than one prominent portion, a subportion of the continuous presence portion may be reserved for participants in the prominent portions, until they are demoted or removed from those prominent portions. For example, the prominent portions of FIGS. 7A-7D may be reserved for the two most active talkers.

Thus, the method described above may be extended to multiple prominent portions in the videoconference.

Embodiments of a subset or all (and portions or all) of the above may be implemented by program instructions stored in a memory medium or carrier medium and executed by a processor.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A non-transitory memory medium comprising program instructions for presenting a videoconference at a first videoconference endpoint, wherein the program instructions are executable to:
display a videoconference layout comprising a plurality of participants during the videoconference;
wherein a first portion of the videoconference layout comprises a plurality of portions for the plurality of participants;
wherein a second portion of the videoconference layout comprises a portion for an active speaker of the plurality of participants;
wherein when a first participant displayed in a first portion of the plurality of portions becomes an active speaker in the videoconference, the first participant is displayed in the second portion of the videoconference layout, and wherein the first portion of the plurality of portions is reserved for the first participant.

2. The non-transitory memory medium of claim 1, wherein when the first participant becomes an active speaker in the videoconference, the first portion of the plurality of portions is blank.

3. The non-transitory memory medium of claim 1, wherein when the first participant becomes an active speaker in the videoconference, the first portion of the plurality of portions comprises a static image.

4. The non-transitory memory medium of claim 1, wherein when the first participant becomes an active speaker in the videoconference, the first participant is also displayed in the first portion of the plurality of portions.

5. The non-transitory memory medium of claim 1, wherein each portion of the plurality of portions is smaller than the second portion of the videoconference layout.

6. A non-transitory memory medium comprising program instructions for presenting a videoconference at a first videoconference endpoint, wherein the program instructions are executable to:
display a videoconference layout comprising a plurality of participants during the videoconference, wherein a first portion of the videoconference layout comprises a plurality of portions for the plurality of participants, wherein an active speaker portion of the videoconference layout comprises a portion for an active speaker of the plurality of participants;
display a first participant in a first portion of the plurality of portions at a first time;
display the first participant in the active speaker portion of the videoconference layout at a second time in response to the first participant becoming an active speaker in the videoconference, wherein the first portion of the plurality of portions is reserved for the first participant while the first participant is displayed in the active speaker portion of the videoconference layout.

7. The non-transitory memory medium of claim 6, wherein the program instructions are further executable to:
display a second participant in a second portion of the plurality of portions at the second time;
display the second participant in the active speaker portion of the videoconference layout at a third time in response to the second participant becoming an active speaker in the videoconference, wherein the second portion of the plurality of portions is reserved for the second participant while the second participant is displayed in the active speaker portion of the videoconference layout.

8. The non-transitory memory medium of claim 6, wherein a number of the plurality of portions is user selectable by a participant at the first videoconference endpoint.

9. The non-transitory memory medium of claim 6, wherein the videoconference layout comprises one or more of the plurality of portions positioned at one of the top or bottom of the videoconference layout, and wherein the active speaker portion is positioned at the other of the top or bottom of the videoconference layout.

10. The non-transitory memory medium of claim 6, wherein the program instructions are further executable to:
receive user input selecting the videoconference layout from a plurality of videoconference layouts.

11. A method for presenting a videoconference at a first videoconference endpoint, the method comprising:
displaying a videoconference layout comprising a plurality of participants during the videoconference, wherein a first portion of the videoconference layout comprises a plurality of portions for the plurality of participants, wherein an active speaker portion of the videoconference layout is for an active speaker of the plurality of participants;
displaying a first participant in a first portion of the plurality of portions;
displaying the first participant in the active speaker portion of the videoconference layout in response to the first participant becoming an active speaker in the videoconference, wherein the first portion of the plurality of portions is reserved for the first participant while the first participant is displayed in the second portion of the videoconference layout.

12. The method of claim 11, wherein the plurality of portions are positioned along a top and side of the videoconference layout or a bottom and side of the videoconference layout.

13. The method of claim 11, wherein the plurality of portions are positioned along a side of the videoconference layout.

14. The method of claim 11, wherein the active speaker portion is positioned in the center of the videoconference layout.

15. The method of claim 11, wherein the first portion of the plurality of portions comprises a static image in response to the first participant becoming an active speaker in the videoconference.

16. A method for conducting a videoconference, comprising:
displaying a videoconference layout at a first time, wherein a first participant is displayed as an active speaker in a first portion of the videoconference layout at the first time, wherein a second portion of the videoconference layout is reserved for the first participant when the first participant is not the active speaker, and wherein a second participant is displayed in a third portion of the videoconference layout during the first time; and
displaying the videoconference layout at a second time, wherein a second participant is displayed as the active speaker at in the first portion of the videoconference layout at the second time, wherein the first participant is displayed in the second portion of the videoconference layout at the second time, wherein the third portion of the videoconference layout is reserved for the second participant when the second participant is not the active speaker.

17. The method of claim 16, wherein the first portion of the videoconference layout is larger than each of the other potions of the videoconference layout.

18. The method of claim 16, wherein, at the first time, the second portion of the videoconference layout is blank.

19. The method of claim 16, wherein, at the first time, the second portion of the videoconference layout comprises a static image corresponding to the first participant.

20. The method of claim 16, further comprising:
displaying the videoconference layout at a third time, wherein a third participant is displayed as the active speaker in the first portion of the videoconference layout, wherein the first participant is displayed in the second portion of the videoconference layout, wherein the second participant is displayed in the third portion of the videoconference layout, and wherein a fourth portion of the videoconference layout is reserved for the third participant when the third participant is not the active speaker.
